(19) United States
(12) Patent Application Publication
(10) Pub. No.: US 2009/0050466 A1
(43) Pub. Date: Feb. 26, 2009

(54) Non-contact pressure switch assembly

(76) Inventors: Michael Andrew Kozan, Canton, MI (US); Duane Zedric Collins, El Paso, TX (US); Samuel Roland Palfenier, El Paso, TX (US)

Correspondence Address: DELPHI TECHNOLOGIES, INC., M/C 480-410-202, PO BOX 5052, TROY, MI, 48007, US

(21) Appl. No.: 11/894,381

(22) Filed: Aug. 21, 2007

(51) Int. Cl. H01H 35/34; H01H 35/38; H01H 36/00

(52) U.S. Cl. 200/82 E; 200/83 J

(57) ABSTRACT

A non-contact pressure switch assembly for sensing pressure in, e.g., a vehicle. A piston with integrated magnet in a housing is moved under fluid pressure to change a magnetic field in which a Hall sensor is disposed inside the housing. The field changes polarity at the Hall sensor at a predetermined piston position.

### FIELD OF THE INVENTION

The present invention relates generally to pressure switches, and more particularly to non-contact pressure switches for vehicles.

### BACKGROUND OF THE INVENTION

Pressure switch manifolds are used in automotive transmission applications for direct sensing of fluid pressure. Applications include hydraulic feedback gear selection, shift timing/feel control, torque converter clutch control, solenoid feedback control, solenoid fault detection, and improved idle control.

As understood herein, contacting technology, in which case hydraulic pressure deflects or moves a diaphragm or spring loaded piston to create a short circuit condition that closes the contacting switch at a predefined hydraulic pressure valve, can be used but these structures are susceptible to contamination, corrosion, and wear. Furthermore, conductive particle contamination can generate the close (short switch) condition without pressure actuation, and corrosion and wear can prevent the close with pressure actuation.

### SUMMARY OF THE INVENTION

A pressure switch assembly has a housing disposable in a fluid and an opening in the housing and in fluid communication with the fluid when the housing is disposed therein. A piston is disposed adjacent the opening for reciprocal movement in the housing. As set forth further below, a magnet is coupled to the piston and a Hall effect sensor is in the housing to output a signal that is affected by the position of the magnet in the housing. A spring urges the piston toward the opening, with fluid pressure urging the piston away from the opening.

In non-limiting embodiments the Hall effect sensor establishes a Hall switch which changes output state from negative to positive at a predetermined position of the magnet in the housing. If desired, the spring and motion of travel of the piston together can establish a pressure switch value. Thus, the magnetic field of the magnet in effect switches polarity relative to the Hall switch at a predetermined position of the magnet relative to the Hall switch.

In some implementations the housing includes a bottom and a base plate flush against the body and defining the opening. A diaphragm can be disposed between the body and base plate.

In another aspect, a method for sensing pressure includes moving a piston under fluid pressure to change a magnetic field in which a Hall sensor is disposed. The field changes polarity at the Hall sensor at a predetermined piston position.

In still another aspect, a non-contact pressure switch assembly for sensing pressure in a vehicle includes a housing, one or more Hall sensors associated with the housing, and one or more respective pistons with respective integrated magnets in the housing. Each piston with magnet is moved under fluid pressure to change a magnetic field in which the Hall sensor is disposed. As contemplated herein, the field changes polarity at the Hall sensor at a predetermined piston position.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is an exploded perspective view of a pressure switch assembly that may incorporate plural pressure switches of the present invention;

FIG. 2 is an exploded perspective view of a single pressure switch in accordance with present principles;

FIG. 3 is a side elevational cut-away view of a non-limiting switch in accordance with present principles in the depressurized configuration;

FIG. 4 is a side elevational cut-away view of a non-limiting switch in accordance with present principles in the pressurized configuration;

FIG. 5 is a side elevational cut-away view of an alternate non-limiting switch that uses an o-ring; and

FIG. 6 is a side elevational cut-away view of an alternate non-limiting switch that uses a lip seal.

### DETAILED DESCRIPTION OF THE PREFERRED EMBODIMENT

The present invention overcomes the drawbacks associated with contacting switches by using a non-contacting magnetic switch. As contemplated herein, the present switch may be used but is not limited to an automotive transmission.

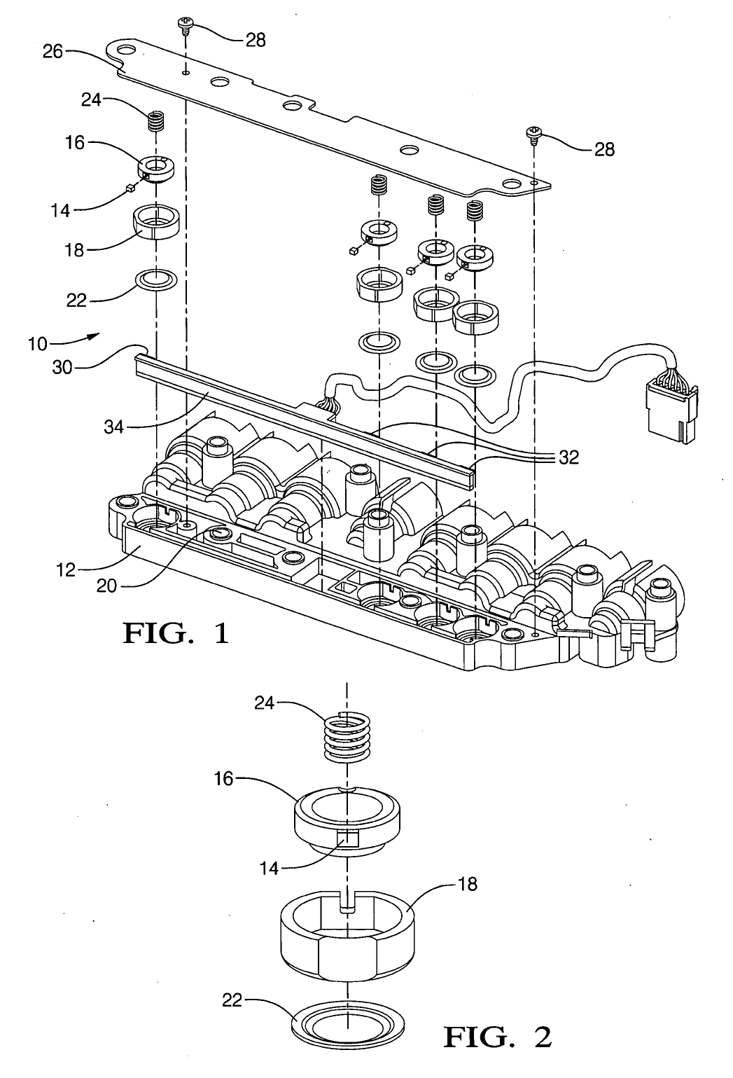

FIG. 1 illustrates a pressure switch assembly, generally labeled 10, and a solenoid body 12 that in non-limiting embodiments holds plural pressure switch assemblies, a single one of which is described as follows for clarity. A filter magnet (not shown) can be provided in each passageway of the solenoid body 12 that holds one of the below-described switches to filter out ferrous contamination.

As shown in FIGS. 1-4, a magnet 14 is integrated as by, e.g., press fitting into a side of a piston 16, which together snugly fit into a piston holder 18, made from a medium such as nylon. Upward pressure through a port 20 in the solenoid body 12 urges against a flexible diaphragm 22, in non-limiting embodiments made from woven backed Vamac.

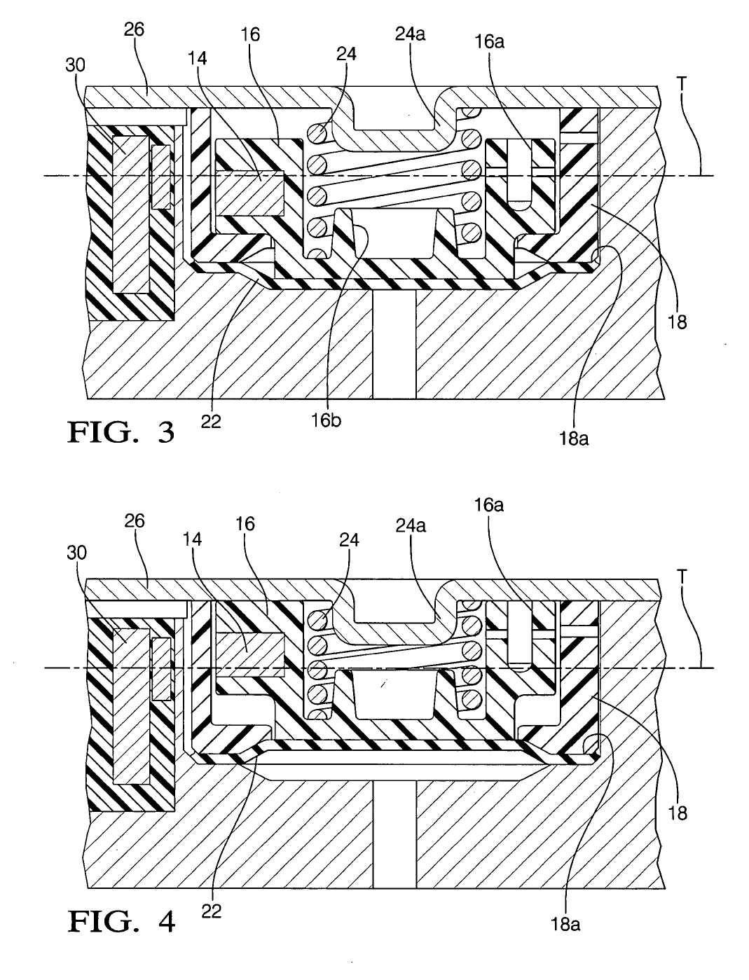

As best shown in cross-reference to FIGS. 3 and 4, the upward force turns the diaphragm 22 inside out and moves the piston 16 and integrated magnet 14 upward, thereby compressing a spring 24, oriented to be partially contained in the piston 16, against a fixed cover 26 (FIG. 1). Screws 28, cover 26, and springs 24 can all be made from steel. That is, when pressure is applied to the diaphragm 22 when in the configuration shown in FIG. 3 (with the holder 18 providing the low pressure stop), the piston 16 with integrated magnet 14 move upward to the position shown in FIG. 4 (in which the cover 26 provides the high pressure stop). The movement of the magnet changes the field through a Hall switch 30 and crosses the sense element's field threshold “T”, shown in FIGS. 3 and 4 by a dashed line. The Hall switch can be fixed into a printed circuit board 34 as shown in FIG. 1, which in turn can be fixed either on top of, or on the side of, the open pressure ports.

As the pressure moves the piston 16 across the sense threshold “T”, the magnetic field at the Hall switch 30 changes direction from a negative to a positive value. It may now be appreciated that the Hall switch 30 changes output state at the threshold “T”, with the spring 24 being pre-loaded to a pre-defined pressure value between the solenoid body 12 and the cover 26 accordingly. Thus, spring 24 selection and piston 16 travel define the pressure switch value, while the Hall switching field and magnetic circuit define the switching position. This magnetic implementation, consisting of using switches in the polarity of the field and a narrow pressure actuation window, provides accurate pressure switching capability. An array of Hall switches 30,32 can be arranged on the printed circuit board 34 or load-frame to detect pressure changes at critical positions within the automotive transmission.

FIG. 2 displays the embodiment that the magnet 14 would be oriented in, more specifically the piston 16. The spring 24 fits into the piston 16, which in turn rests in the non-moving holder 18. The three components, situated in a stacked position, are set on the diaphragm 22.

As mentioned above, the dashed line “T” in FIG. 3 and FIG. 4 represents the position of the magnet 14 at which the magnetic field at the Hall switch 30 switches polarity. In FIG. 3, the magnet 14 is situated below the Hall switching field threshold position “T”. In FIG. 4, the magnet 14 is situated above the Hall switching field threshold “T” due to applied pressure on diaphragm 22 that moves the piston 16 and magnet 14 up, thereby compressing the spring 24 against the cover 26. The difference in position of the magnet 14 between above or below the Hall switching field defines the output of the Hall switch 30.

FIGS. 3 and 4 also show that if desired, the piston 16 may be formed with one or more exhaust slots 16a to provide an exhaust path for fluid during piston actuation. In non-limiting implementations the holder 18 may include annular crush ribs 18a to compress the diaphragm 22 for better engagement. If desired, the cover 26 may include a central alignment dome 26a to align the spring 24, while the piston 16 may include a central annular wall 16b for the same purpose.

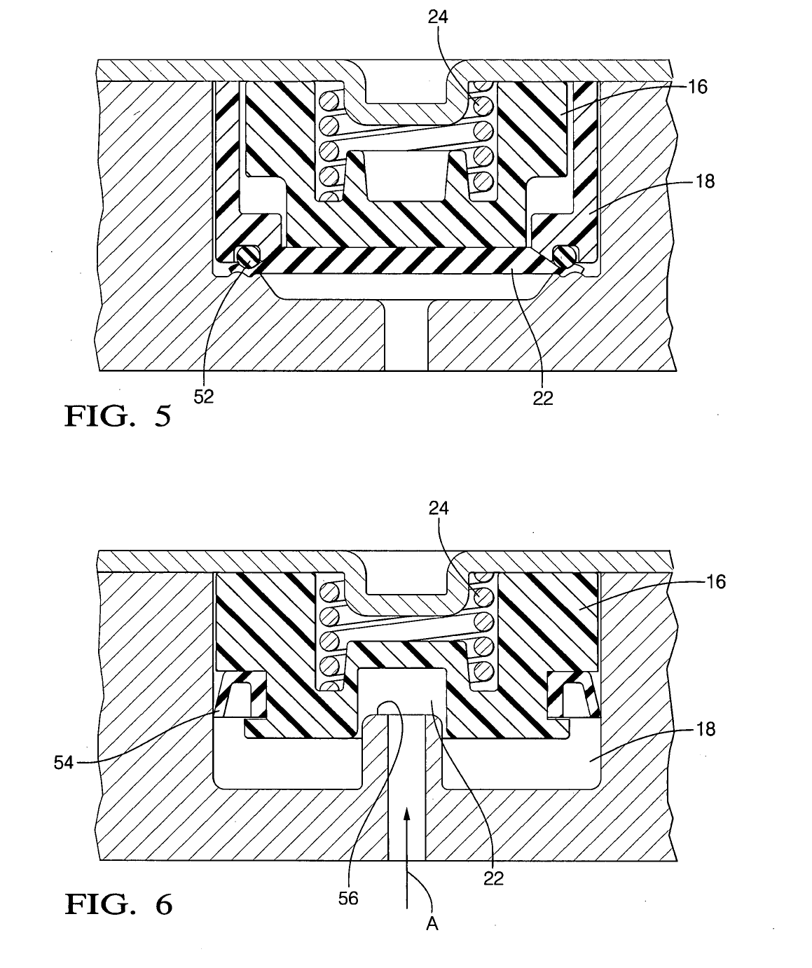

FIGS. 5 and 6 show alternate embodiments for the spring 24, piston 16, holder 18, and diaphragm 22. The arrow “A” represents the upward pressure that moves the diaphragm 22. The diaphragm 22 is compressed between body and base plate to prevent fluid leakage and pressure losses into the reference cavity.

In FIG. 5, an o-ring 52 is provided between the diaphragm 22 and holder 18 to compress the diaphragm, with the diaphragm sealing the holder from pressure. In FIG. 6, on the other hand, an annular seal 54 that is “V”-shaped in cross-section replaces the o-ring. Also, FIG. 6 illustrates that a non-circular interface 56 can be provided between the piston and holder to prevent rotation of the piston if desired.

While the particular NON-CONTACT PRESSURE SWITCH ASSEMBLY is herein shown and described in detail, it is to be understood that the subject matter which is encompassed by the present invention is limited only by the claims.

What is claimed is:

1. A pressure switch assembly, comprising:
a housing disposable in a fluid;
an opening in the housing, the opening being in fluid communication with the fluid when the housing is disposed therein;
a piston disposed adjacent the opening for reciprocal movement in the housing;
at least one magnet coupled to the piston for movement therewith;
at least one Hall effect sensor in the housing and outputting a signal that is affected by the position of the magnet in the housing; and
a spring urging the piston toward the opening, fluid pressure urging the piston away from the opening.

2. The pressure switch assembly of claim 1, wherein the Hall effect sensor establishes at least in part a Hall switch changing output state from negative to positive at a predetermined position of the magnet in the housing.

3. The pressure switch assembly of claim 2, wherein the spring and motion of travel of the piston together establish a pressure switch value.

4. The pressure switch assembly of claim 2, wherein the magnetic field of the magnet switches polarity relative to the Hall switch at a predetermined position of the magnet relative to the Hall switch.

5. The pressure switch assembly of claim 1, wherein the housing includes a bottom and a base plate flush against the body and defining the opening, a diaphragm being disposed between the body and base plate.

6. A method for sensing pressure, comprising moving a piston under fluid pressure to change a magnetic field in which a Hall sensor is disposed, the field changing polarity at the Hall sensor at a predetermined piston position.

7. The method of claim 6, wherein the piston is in a housing having an opening, and the housing is disposed in the fluid such that the opening is in fluid communication with the fluid.

8. The method of claim 7, comprising coupling the piston to at least one magnet, wherein the Hall sensor outputs a signal that is affected by the position of the magnet in the housing and hence represents pressure.

9. The method of claim 8, comprising disposing a spring in the housing such that the spring urges the piston toward the opening, with fluid pressure urging the piston away from the opening.

10. The method of claim 7, wherein the Hall sensor establishes at least in part a Hall switch changing output state from negative to positive at a predetermined position of the magnet in the housing.

11. The method of claim 9, wherein the spring and motion of travel of the piston together establish a pressure switch value.

12. The method of claim 8, wherein the magnetic field of the magnet switches polarity relative to the Hall sensor at a predetermined position of the magnet relative to the Hall sensor.

13. The method of claim 7, wherein the housing includes a bottom and a base plate flush against the body and defining the opening, a diaphragm being disposed between the body and base plate.

14. A non-contact pressure switch assembly for sensing pressure in a vehicle, comprising:
at least one housing;
at least one Hall sensor associated with the housing;
at least one piston with integrated magnet the housing, the piston with magnet being moved under fluid pressure to change a magnetic field in which the Hall sensor is disposed, wherein the field changes polarity at the Hall sensor at a predetermined piston position.

15. The pressure switch assembly of claim 14, wherein an opening is in the housing and the opening is in fluid communication with fluid when the housing is disposed therein, the piston being disposed adjacent the opening for reciprocal movement in the housing.

16. The pressure switch assembly of claim 15, comprising a spring urging the piston toward the opening, fluid pressure urging the piston away from the opening.

17. The pressure switch assembly of claim 14, wherein the Hall effect sensor establishes at least in part a Hall switch changing output state from negative to positive at a predetermined position of the magnet in the housing.

18. The pressure switch assembly of claim 16, wherein the spring and motion of travel of the piston together establish a pressure switch value.

19. The pressure switch assembly of claim 14, wherein the magnetic field of the magnet switches polarity relative to the Hall sensor at a predetermined position of the magnet relative to the Hall sensor.

20. The pressure switch assembly of claim 15, wherein the housing includes a bottom and a base plate flush against the body and defining the opening, a diaphragm being disposed between the body and base plate.
